(19) United States
(12) Patent Application Publication
(10) Pub. No.: US 2016/0030869 A1
(43) Pub. Date: Feb. 4, 2016

(54) AIR FILTER DEVICE AND AIR FITLER ELEMENT HAVING AN INTEGRATED BYPASS

(71) Applicant: MANN+HUMMEL GMBH, Ludwigsburg (DE)

(72) Inventors: Erich Fedak, Kalamazoo, MI (US); John Autry, Fayetteville, NC (US); Gregg Updike, Galesburg, MI (US)

(21) Appl. No.: 14/815,580

(22) Filed: Jul. 31, 2015

Related U.S. Application Data
(60) Provisional application No. 62/031,715, filed on Jul. 31, 2014.

(51) Int. Cl. B01D 46/00; B01D 39/16; B01D 46/52

(52) U.S. Cl. CPC B01D 46/002; B01D 46/0005; B01D 46/521; B01D 39/1692; B01D 39/1615; B01D 39/1623

(57) ABSTRACT

A filter element has a filter media hollow body with a hollow interior circumferentially enclosing an outflow passage. A second filter as a bypass filter element is arranged at or integrated into the end cap the filter element. The bypass filter element is configured as an ambient airflow restriction device providing a significantly higher pressure drop relative to the in the filter media of the filter element, the significantly higher pressure drop is operable to limit or prevent airflow through the auxiliary inflow path. When the primary inflow path is obstructed, the ambient airflow restriction device operates to provide auxiliary airflow into the outflow passage, bypassing filtering of the filter media hollow body of the filter element.

### CROSS REFERENCE TO RELATED APPLICATIONS

This application claims the benefit of U.S. Provisional Patent Application No. 62/031,715, filed Jul. 31, 2014 entitled “AIR FILTER DEVICE HAVING AN INTEGRATED BYPASS FILTER AND AIR CLEANER”.

### TECHNICAL FIELD

The invention relates to an air filter device with an filter element delivering filtered air to a filtered air system, for example, to an internal combustion engine air intake system, and having an integrated auxiliary or bypass flow arrangement configured to continue to supply filtered airflow in the event the primary airflow path becomes obstructed.

### BACKGROUND OF THE INVENTION

Internal combustion engines and other air consuming machines require a reliable source of filtered air, free of contaminants. Air filter devices and air filter elements are typically applied to such applications to condition ambient. Unfortunately, when operated in colder climates where heavy or blowing snow is common, blowing snow may be drawn into the air filter device and obstruct air flow through the filter element. Additionally, the filter element may become obstructed due to other factors, such as unexpected accumulation of dust or other debris. In internal combustion engines, this may lead to insufficient combustion airflow through the filter element and resulting poor engine performance.

U.S. Pat. No. 6,395,048 discloses a filter device having an annular door with an open window that is rotatable between a first and a second position. In the first position outside air is admitted to the filter element. In the second position warmer under the hood air is delivered to the filter device and the normal outside air is blocked.

US Publication 2010/0186596 A1 discloses an air cleaner for a motor vehicle having a valve in the housing wall configured to open and supply secondary airflow in the event the vacuum in the housing increases to a predetermined level, such as when obstructed by snow.

As can be understood from the above, known air filtration devices with secondary air or bypass air configurations have a number of moving parts, are more complex, impacting cost and reliability.

### SUMMARY OF THE INVENTION

An object of the present invention is to provide a filter device having an integrated bypass filter element which additionally may function as an airflow restriction device.

In one aspect of the invention the filter device includes a filter housing having an interior chamber and a primary filter element arranged within the interior chamber. The primary filter element may include a filter media forming a generally cylindrical, oval, rectangular or oblong filter media hollow body and having an axially extending hollow interior circumferentially enclosing an outflow passage in an interior of the primary filter element. A first end disk may be provided on the primary filter element and secured onto a first axial end of the filter media hollow body. The first end disk may or may not cover the end face of filter media. The first end disk includes a through opening that may be a central opening extending axially through the first end disk and forming an auxiliary inflow path opening extending from an exterior of the primary filter element into the hollow interior.

The primary filter element is configured such that a primary inflow path enters the primary filter element at the inflow face, is filtered by the primary filter element and reaches the outflow passage within the hollow interior. An integrated bypass filter element is configured as an ambient airflow restriction device and closes over the central opening such that auxiliary airflow entering through the central opening passes through the ambient airflow restriction device before reaching the hollow interior of the primary filter element.

The ambient airflow restriction device is configured with a porous media having a significantly higher pressure drop at a given flow rate relative to a pressure drop in the primary filter element filter media from equivalent airflow rate in the primary inflow path, the significantly higher pressure drop is operable to limit or prevent airflow through the auxiliary inflow path into the interior of the primary filter element, at least in normal operation. When the primary inflow path is obstructed, the ambient airflow restriction device operates to provide auxiliary airflow into the outflow passage in the hollow interior directly through the end disk, bypassing the filtering of the filter media hollow body of the primary filter element. In this way an uninterrupted flow of air is provided.

The ambient airflow restriction device includes one or more filter media layers. A first layer may be an open pore foam media, such as a porous foam block, or may be another layer material such a synthetic non-woven or filter paper. A second layer, when present, may advantageously be a cellulose or synthetic fiber filter layer which may be a pleated filter layer to increase the available filtering surface area. The second layer may be arranged on the outflow face of the first layer.

In some aspects of the invention, the ambient airflow restriction device is replaceably secured directly to the filter housing and not secured onto the primary filter element. The ambient airflow restriction device covers over the auxiliary air inflow opening of the housing and is received into the hollow interior of the primary filter element.

In another aspect of the invention, the ambient airflow restriction device is secured to the first end disk of the primary filter element and arranged within the hollow interior. The first end disk forms an axially inwardly extending annular wall which circumferentially surrounds and extends the central opening through the first end disk into the hollow interior. The ambient airflow restriction device is arranged within the inwardly extending annular wall of the first end disk.

In another aspect of the invention, the ambient airflow restriction device has a first portion having a first filter media and a second portion having a second filter media. The first portion is integrated into and covering the central opening of the first end disk of the primary filter element. The second portion is arranged external to and under the filter element and the first portion. The second portion is in flow communication with the first portion. The second portion may be replaceably secured directly onto the filter housing and not secured onto the primary filter element. The second portion covers overs over the auxiliary air inflow opening of the housing.

The second portion may be received into a receptacle chamber formed by axially inwardly extending housing walls which circumferentially surround the inflow path opening of the housing. The second portion may be held within the receptacle chamber by the inwardly extending housing walls between a housing bottom wall and the primary filter element. Preferably the first end disk is supported on the axially inwardly extending housing walls.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 depicts side sectional schematic view of a filter device with a housing in which a exchangeable filter element including an integrated bypass filter is installed, consistent with the present invention;

FIG. 2 depicts a side sectional schematic view of a variant of the filter device of FIG. 1 in which the bypass filter is replaceably integrated in the housing and received into an interior of the exchangeable filter element;

FIG. 2A is an enlargement of the portion dashed region 2A of FIG. 2, showing an enlargement of bypass filter is replaceably integrated in the housing, more clearly showing features replaceably mounting the exchangeable bypass filter into the housing, consistent with the present invention;

FIG. 3 depicts a side sectional schematic view of another variant of the filter device and exchangeable filter element having an integrated bypass filter, consistent with the present invention;

FIG. 4 depicts a bottom-side perspective view of the exchangeable filter element of FIG. 3 installable into the filter housing of FIG. 3, showing details of a bypass filter integrated into the exchangeable filter element, consistent with the present invention;

FIG. 5 depicts a bottom-side perspective view of the exchangeable filter element of FIG. 1 installable into the filter housing of FIG. 1, consistent with the present invention; and

FIG. 6 depicts a bottom-side perspective view of an oval or round exchangeable filter element, showing details of a bypass filter integrated into the exchangeable filter element, consistent with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to a filter apparatus. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

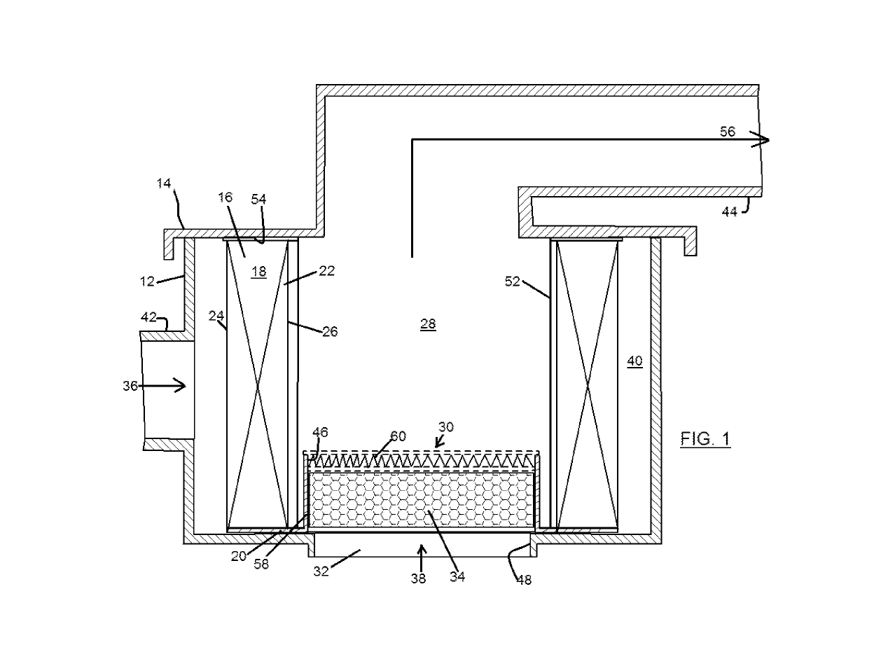

FIG. 1 depicts a side sectional schematic view of a filter device 10 having a housing 12 into which an exchangeable filter element 16 is exchangeably/replaceably installed. The filter element has a circumferential wall of filter media 18 forming a filter media hollow body 22 having a hollow or open interior 28 for flow. The filter element 16 may be an oval, round, rectangular or oblong filter element, for example, preferably with the filter media 18 enclosing a hollow interior 28 within the filter element 16.

In embodiments disclosed herein, the filter media may include any of a cellulose filter media, a synthetic woven or a non-woven synthetic filter media such as spun bond or melt blown, and/or a porous foam media, although the disclosed filter element and concepts presented herein may also include other filter media types as would be known to those skilled in the art.

The filter element 16 has a first end disk 20 at a first axial end of the filter element and may include a second end disk 54 at an opposing second axial end of the filter element. Both end disks may preferably have a central opening extending through the end disk into the hollow interior of the filter element.

In normal operation, air to be filtered enters the filter device 10 housing 12 air inflow port 42 along the primary inflow path 36 reach the circumferential inlet flow face 24 of the filter element 16. In the embodiments disclosed herein, the inlet flow face 24 is the radially outer face of the filter media 18 of the filter element 16. The air in primary inflow path is filtered through the filter media 18 to exit at the outlet flow face 26 of the filter media 18 and enter the hollow interior 28 of the filter element 16. The hollow interior 28 forms the head of the outflow path 56 which exits the filter element 16 hollow interior 28 and then exit the filter device 10 as filtered air at the air outflow port 44 of the filter housing 12, in the embodiment of FIGS. 1-3 the outflow port may be arranged on the filter housing cover 14 of the filter housing 12, although it is to be understood that the air outflow port may be also arranged on other portions of the filter housing 12 without deviating from the present inventive disclosure.

Advantageously, in all embodiments of the present inventive disclosure, the filter element 16 provides two separate air paths 36, 38 which permit airflow to enter the filter element 16 and reach the hollow interior 28 to flow to the outflow path 56. The device will allow air travel through and be filtered via the auxiliary inflow path 38 in the event that the primary inflow path 36 becomes blocked or obstructed, for example but not limited to an accumulation of snow or debris preventing passage of air though the filter element 16 at the inlet flow face 24. In this case, airflow into the hollow interior 28 of the filter element 16 is maintained by airflow along the auxiliary inflow path 38 through the central opening 32 at the first axial end of the filter element 16. According to the present invention, air would pass through this auxiliary inflow path 38 when there is an elevated vacuum (negative pressure) in the hollow interior 28 or an increased differential pressure between the pressure in the auxiliary inflow path 38 upstream if the filter device 10 and the pressure in the hollow interior 28 of the filter element 16. The passage of airflow into the central opening 32 of the first end disk 20 of the filter element 16 advantageously provides an uninterrupted flow of air to filtered air consumers (not shown) such as for combustion air to an internal combustion engine (not shown).

Advantageously, in all embodiments of the present inventive disclosure presented in this disclosure, the auxiliary inflow path 38 includes an ambient airflow restriction device 30 which is also a bypass filter element filtering airflow in the auxiliary inflow path 38 entering the hollow interior 28 of the filter element 16. Preferably, the ambient airflow restriction device 30 includes one or more filter media type having a porosity presenting an elevated pressure drop relative to the pressure drop across the filter media 18 from the inlet inflow face 24 to the outlet flow face 26 at normal filter air flow rates of the outflow path 56 such that, in normal non-obstructed operation, airflow through the filter device 10 is substantially entirely from the primary inflow path 36 and not the auxiliary inflow path 38, again due to the substantially higher restriction to airflow through the ambient airflow restriction device 30 relative to the filter media 18 of the filter element 16.

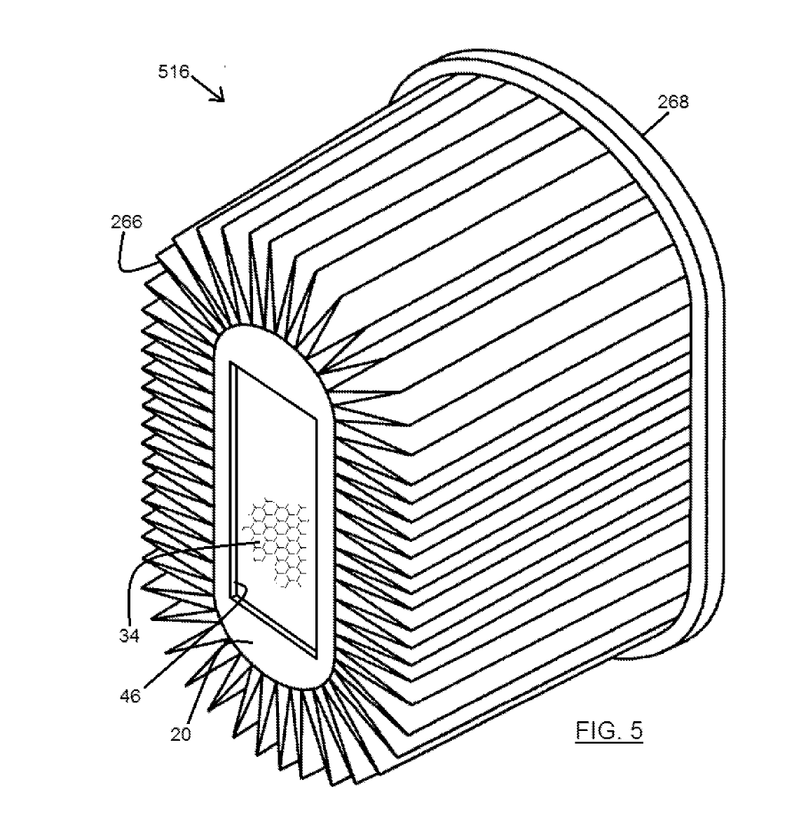

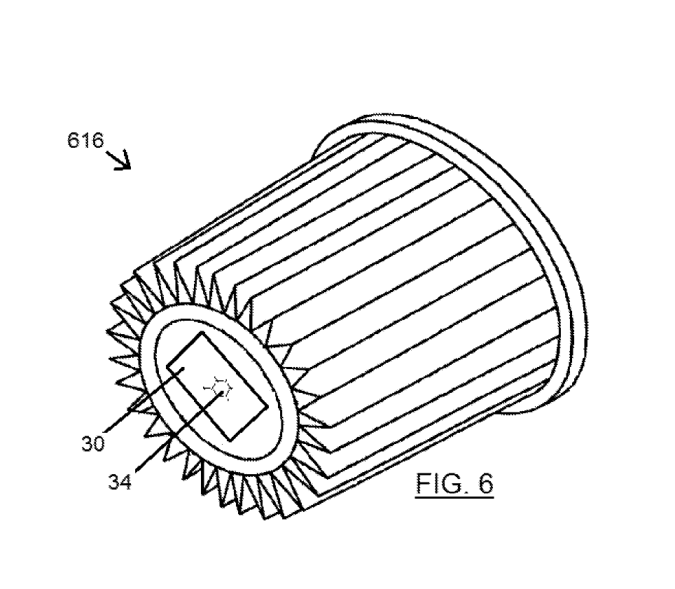

In the embodiment according to FIG. 1 the filter element 16 has an ambient airflow restriction device 30 preferably integrated as a one-piece unit with the filter element 16 and arranged within the hollow interior 28 of the filter element 16. In FIG. 1, the filter element 16 has a first end disk 20 arranged a first axial end of the filter element 16. The first end disk has a central opening 32 opening through the first end disk 20 from an axial exterior of the filter element into the open interior of the filter element. The first end disk may include an axially inwardly extending annular wall 58 which circumferentially surrounds and extends the central opening 32 through the first end disk 20. The annular wall 58 provides a wall circumferentially surrounds a space into which one or more filter media are arranged to form the ambient airflow restriction device 30, which preferably also performs as an auxiliary filtering device to effectively filter the auxiliary inflow path 38. As shown in FIG. 1, the ambient airflow restriction device 30 may include one or more filter media in a stacked or sequential flow through arrangement. For an advantageous example, the ambient airflow restriction device 30 may include a pleated or non-pleated filter paper or synthetic filter sheet media 60. Upstream of the filter media 60 a porous media 34 of an open pore foam 34 may be arranged. In sequential combination, the open pore foam media 34 together with the pleated or non-pleated filter paper or synthetic filter sheet media 60 are selected and configured to provide a combined porosity presenting an elevated pressure drop relative to the pressure drop across the filter media 18 from the inlet inflow face 24 to the outlet flow face 26 at normal filter air flow rates of the outflow path 56 such that, in normal non-obstructed operation, airflow through the filter device 10 is substantially entirely from the primary inflow path 36 and not the auxiliary inflow path 38, again due to the substantially higher restriction to airflow through the ambient airflow restriction device 30 relative to the filter media 18 of the filter element 16. Refer to FIGS. 5 and 6 for perspective views of similar or variants of the filter elements as disclosed in FIG. 1 having an integrated ambient airflow restriction device 30 operational as an integrated bypass filter element 30.

As shown in FIG. 1, the first end disk 20 of the filter element16 may form the annular wall or circumferential housing of the ambient airflow restriction device 30. The first end disk 20 preferably sealably closes against the interior of the housing around the auxiliary inflow path opening 48 of the housing to sealably close between the auxiliary inflow path 46 and the primary inflow path 36.

In FIG. 1, the ambient airflow restriction device 30 is integrated with the filter element 16 forming a one piece filter element component installed and replaced as a unit.

A support structure or support tube 52 may be arranged at the outlet flow face 26 of the filter element 16 to support the filter media 18 against deformation. The support tube 52 may be secured to the first end disk 20 and/or the second end disk 54. The filter media 18 is preferably a pleated filter media so to increase available filtering surface area.

Preferably, the filter housing 12 has a removable filter housing cover 16 permitting the filter housing to be opened for service and replacement of the filter element 16 in the filter device 10.

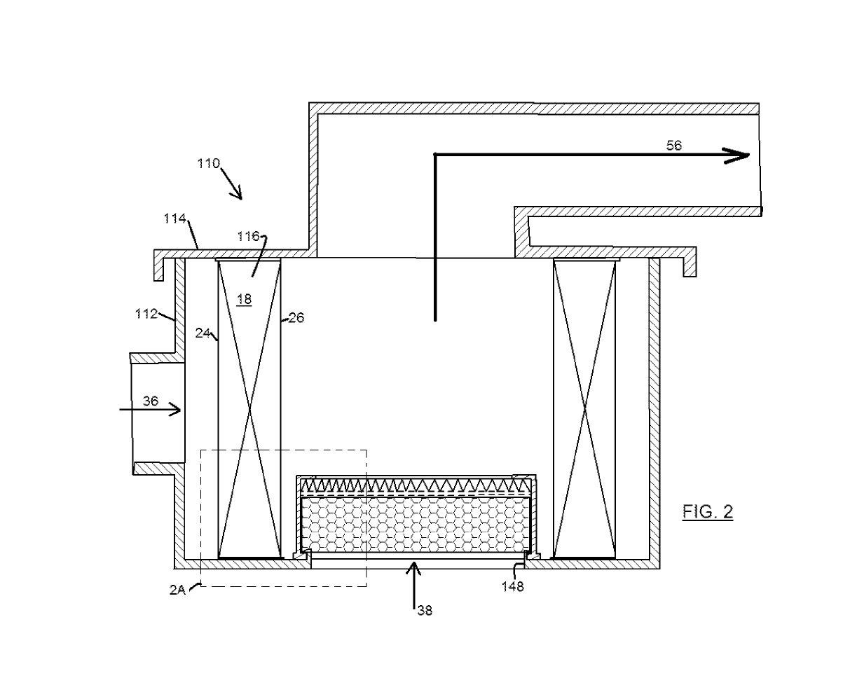

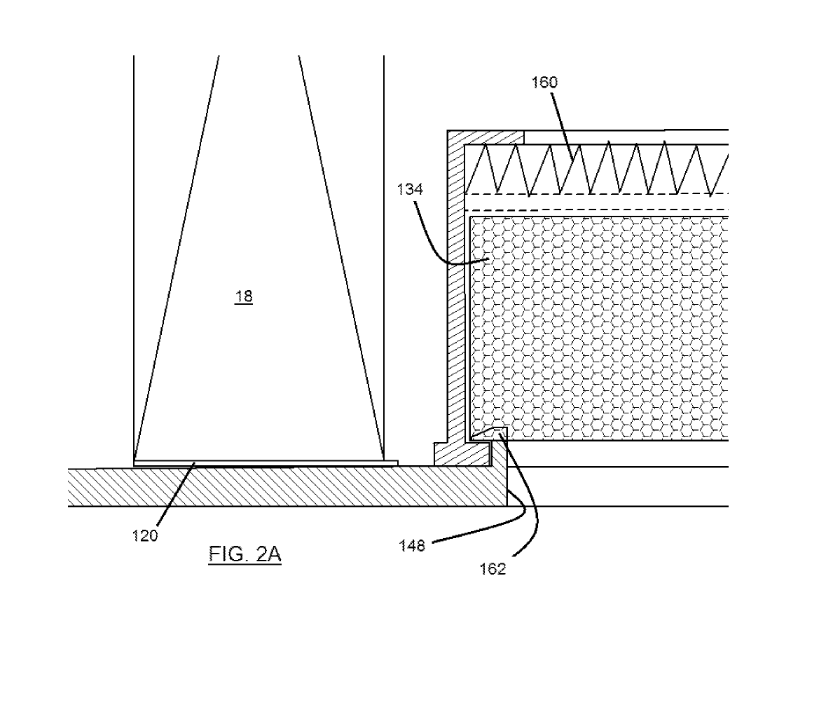

FIG. 2 depicts a side sectional schematic view of another embodiment of the filter device of FIG. 1 in which the ambient airflow restriction device 130 is replaceably integrated with the housing 112 and received into an interior of the exchangeable filter element 116., while in FIG. 1 the ambient airflow restriction device is integrated with the filter element. FIG. 2A is an enlargement of the dashed region 2A of FIG. 2, showing an enlargement of the ambient airflow restriction device 130 replaceably integrated in the housing 112.

Components which are the same as those of FIG. 1 are shown with the same numbers and the previously presented description of FIG. 1 is applicable to these also. Components which are similar in form or function to those of FIG. 1 but differ from FIG. 1 are shown with reference numbers incremented by 100.

In FIG. 2, the ambient airflow restriction device 130 is replaceably integrated with the housing 112, and may be detachably secured to the housing to cover the auxiliary inflow path opening 148 by deformable snap mounts 162 provided on the housing wall surround the auxiliary inflow path opening 148. The ambient airflow restriction device 130 includes an axially inwardly extending annular wall 158 defining an auxiliary inflow opening 146 into which one or more filter media are arranged to form the replaceable ambient airflow restriction device 130, which preferably also performs as an bypass filtering device to effectively filter the auxiliary inflow path 138. As shown in FIGS. 1, 2 and 2A, the ambient airflow restriction device 130 may include one or more filter media in a stacked or sequential flow through arrangement. For an advantageous example, the ambient airflow restriction device 130 may include a pleated or non-pleated filter paper or synthetic filter sheet media 160. Upstream of the filter media 160 a porous media 134 of an open pore foam 134 may be arranged. In sequential combination, the open pore foam media 134 tougher with the pleated or non-pleated filter paper or synthetic filter sheet media 160 provide a combined porosity presenting an elevated pressure drop relative to the pressure drop across the filter media 18 from the inlet inflow face 24 to the outlet flow face 26 at normal filter air flow rates of the outflow path 56 such that, in normal non-obstructed operation, airflow through the filter device 110 is substantially entirely from the primary inflow path 36 and not the auxiliary inflow path 38, again due to the substantially higher restriction to airflow through the ambient airflow restriction device 130 relative to the filter media 18 of the filter element 116.

As previously discussed in FIG. 1, the first end disk 120 of the filter element 116 preferably sealably closes against the interior of the housing 112 around the auxiliary inflow path opening 148 of the housing 112 to sealably close between the auxiliary inflow path 38 and the primary inflow path 36.

As discussed and shown in FIG. 1, in FIGS. 2 and 2A a support structure or support tube 52 (see FIG. 1) may be arranged at the outlet flow face 26 of the filter element 116 to support the filter media 18 against deformation. The filter media 18 is preferably a pleated filter media to increase filtering surface area.

Preferably, the filter housing 112 has a removable filter housing cover 114 permitting the filter housing 112 to be opened for service and replacement of the filter element 116 in the filter device 110.

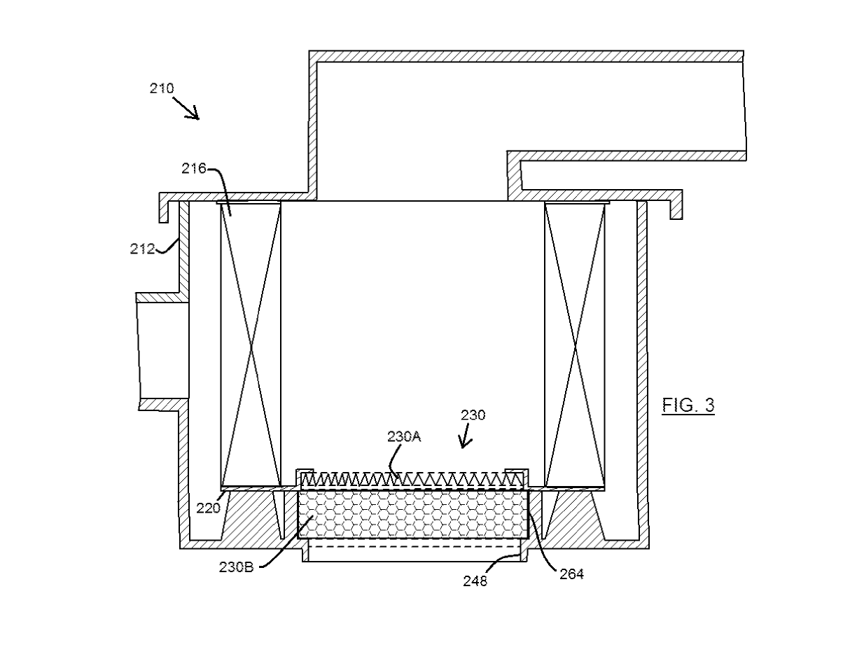

FIG. 3 depicts a side sectional schematic view of another variant of the filter device and exchangeable filter element, similar but not identical to the filter elements and housings of FIGS. 1, 2 and 2A. As discussed and shown in FIG. 1, in FIG. 3a support structure or support tube 52 (see FIG. 1) may be arranged at the outlet flow face 26 of the filter element 216 to support the filter media 18 against deformation. The filter media 18 is preferably a pleated filter media to increase filtering surface area.

In FIG. 3 the ambient airflow restriction device 230 has a first portion 230A integrated into and covering the central opening 232 of the first end disk 220 of the filter element 216. The first portion 230A is in flow communication with and arranged over a second portion 230B of the ambient airflow restriction device 230. The second portion 230B is arranged under the filter element 216 and in flow communication with the first portion 230A. As shown in FIG. 3, the first portion 230A is preferably a pleated or sheet filter media, such as (for example) a cellulose filter media. Filter media types for the ambient airflow restriction device 230 were previously discussed with FIG. 1 herein. As shown in FIG. 3, the second portion 230B is preferably an open pour foam.

Theory and operation of the ambient airflow restriction device 230 was previously discussed in the context of FIG. 1, the discussion directly relevant to the ambient airflow restriction device 230, filter device 210 and filter element 216 of FIG. 3.

In FIG. 3, the second portion 230B of the ambient airflow restriction device 230 is arranged external to and positioned under the filter element 216 and the first end disk 220. The second portion 230B may be received into a chamber 264 form by axially inwardly extending housing walls or walls circumferentially surrounding the inflow path opening 248 of the housing. The second portion 230B is preferably configured to be received into the chamber 264 and be held within the chamber 264 by the inwardly extending housing walls or walls circumferentially surrounding the inflow path opening 248 and between the housing bottom wall and the filter element 216. In this way, the first portion 230A is integrated with the filter element 216 is a exchanged as a unit with the filter element 216. The second portion 230B is arranged in and received in a chamber 264 formed by inwardly extending housing walls or walls circumferentially surrounding the inflow path opening 248 and so it remaining in the housing when the filter element 216 is removed. Preferably the second portion 230B is exchangeable from the filter housing 212 and may be replaced separately when the filter element 216 is replaced.

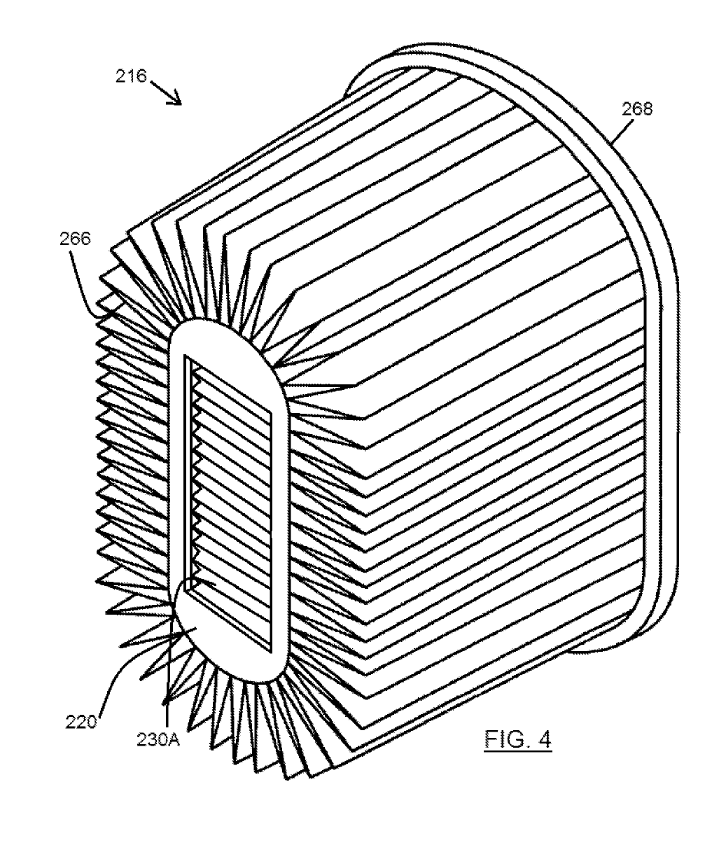

FIG. 4 depicts a bottom-side perspective view of a variant of the exchangeable filter element 216 of FIG. 3 installable into the filter housing of FIG. 3. The filter element of FIG. 4 differs from the filter element of FIG. 3 in that the first end disk 220 does not fully cover the filter media axial end face 266, while in FIG. 3 the filter media axial end face is presented as covered. Alternately, the filter media axial end face 266 may be covered by a annular sealing ring of an elastomeric sealing material, and the first end disk 220 may be, for example, a plastic end disk that is received into the radial interior of the annular sealing ring and may optionally be embedded into the elastomeric sealing material of the annular sealing ring. As shown best in FIG. 4, filter elements disclosed herein in Figures and descriptions may preferably include an annular elastomeric seal 268 arranged on an opposing axial end of the filter element. The annular elastomeric seal 268 may extend axially outwardly from the filter media to form an axial seal with a housing, and/or may extend radially outwardly to potentially form a radial seal with the housing into which the filter element is to be installed.

FIG. 5 depicts a bottom-side perspective view of an exchangeable filter element exchangeable filter element 616 having an integrated bypass filter element/ambient airflow restriction device 30, similar to filter element 16 of FIG. 1 installable into the filter housing of FIG. 1. The filter element 516 of FIG. 5 differs from the filter element 16 of FIG. 1 in that the first end disk 20 does not fully cover the filter media axial end face 266, while in FIG. 1 the filter media axial end face is covered by the end disk 20. Either configuration is envisioned. Alternately, the filter media axial end face 266 may be covered by a annular sealing ring of an elastomeric sealing material, and the first end disk 20 may be, for example, a plastic end disk that is received into the radial interior of the annular sealing ring and may optionally be embedded into the elastomeric sealing material of the annular sealing ring. As also shown in FIG. 1, the porous media 34 of the ambient airflow restriction device 30 may be seen through the auxiliary inflow opening 46 of the filter element 516. As in FIG. 4, filter elements disclosed herein in the Figures and descriptions may preferably include an annular elastomeric seal 268 arranged on an opposing axial end of the filter element. The annular elastomeric seal 268 may extend axially outwardly from the filter media to form an axial seal with a housing, and/or may extend radially outwardly to potentially form a radial seal with the housing into which the filter element is to be installed.

FIG. 6 depicts a bottom-side perspective view of an oval or round exchangeable filter element 616 having an integrated bypass filter element/ambient airflow restriction device 30. FIG. 6. differs from FIG. 5 in that the filter element 616 is oval or round, rather than oblong.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A filter device having an integrated bypass filter element, comprising:
a filter housing including:
an interior chamber;
an air inlet port;
an air outlet port;
an auxiliary air inflow opening;
a primary filter element arranged within the interior chamber, the primary filter element including:
a filter media forming a generally cylindrical, oval, rectangular or oblong filter media hollow body having an axially extending hollow interior circumferentially enclosing an outflow passage in an interior of the primary filter element, the filter media hollow body having:
an inlet flow face arranged on a radially exterior side of the filter media hollow body, the inlet flow face configured to receive air to be filter by the primary filter element;
an outlet flow face arranged in the axially extending hollow interior of the primary filter element;
wherein the fluid to be filtered flows radially through the filter media hollow body from the inlet flow face to the outlet flow face;
a first end disk secured onto a first axial end of the filter media hollow body,
the first end disk having a central opening extending axially through the first end disk, forming an auxiliary inflow path opening extending from an exterior of the primary filter element into the hollow interior;
wherein the primary filter element is configured such that a primary inflow path enters the primary filter element at the inflow face, is filtered by the primary filter element and reaches the outflow passage within the hollow interior;
an ambient airflow restriction device closing the central opening such that auxiliary airflow entering through the central opening passes through the ambient airflow restriction device before reaching the hollow interior of the primary filter element;
wherein the ambient airflow restriction device includes filter media and operates as the bypass filter element;
wherein the ambient airflow restriction device is configured with a porous media having a significantly higher pressure drop at a given flow rate relative to a pressure drop in the primary filter element from equivalent airflow rate in the primary inflow path, the significantly higher pressure drop operable to limit or prevent airflow through the auxiliary inflow path during normal operation;
wherein, when the primary inflow path is obstructed, the ambient airflow restriction device operates to provide auxiliary airflow into the outflow passage, bypassing the filter media of the filter media hollow body.

2. The filter device according to claim 1, wherein
the ambient airflow restriction device is arranged in the hollow interior of the primary filter element, the ambient airflow restriction device closing over the central opening of the first end disk such that flow through the central opening is required to pass through the ambient airflow restriction device to enter the hollow interior.

3. The filter device according to claim 1, wherein
the porous media is a porous foam material;
the ambient airflow restriction device includes a second media layer as a cellulose or synthetic filter media arranged on an outflow side of the open cell foam material.

4. The filter device according to claim 1, wherein
the ambient airflow restriction device (30) is replaceably secured directly to the filter housing and not secured onto the primary filter element;
wherein the ambient airflow restriction device (30) covers over the auxiliary air inflow opening of the housing;
wherein the ambient airflow restriction device is received at least partially into the hollow interior of the primary filter element.

5. The filter device according to claim 2, wherein
the ambient airflow restriction device is secured to the first end disk of the primary filter element and arranged within the hollow interior;
wherein the first end disk forms an axially inwardly extending annular wall which circumferentially surrounds and extends the central opening through the first end disk into the hollow interior;
wherein the ambient airflow restriction device is arranged within the inwardly extending annular wall of the first end disk;

6. The filter device according to claim 1, wherein
the ambient airflow restriction device has a first portion having a first filter media and a second portion having a second filter media;
wherein the first portion integrated into and covering the central opening of the first end disk of the primary filter element;
wherein the second portion is arranged external to and under the primary filter element and the first portion, the second portion is in flow communication with the first portion;
wherein the second portion is replaceably secured directly onto the filter housing and not secured to the primary filter element;
wherein the second portion covers overs over the auxiliary air inflow opening of the housing.

7. The filter device according to claim 6, wherein
the second portion is received into a receptacle chamber formed by axially inwardly extending housing walls which circumferentially surround the inflow path opening of the housing;
wherein the second portion is received into the receptacle chamber and is held within the receptacle chamber by the inwardly extending housing walls between a housing bottom wall and the primary filter element;
wherein the first end disk is supported on the axially inwardly extending housing walls.

8. The filter device according to claim 7, wherein
the second portion an open pore foam filter media;
wherein the first portion is a cellulose or synthetic filter media arranged on an outflow side of the open cell foam;

9. The filter device according to claim 2, wherein
the porous media is a cellulose or synthetic filter media.

10. The filter device according to claim 5, wherein
the primary filter element together with the ambient airflow restriction device together is a unitary one-piece component installed and replaced in the housing as a single unit.

11. A primary filter element having an integrated bypass filter element, comprising:
a filter media forming a generally cylindrical, oval, rectangular or oblong filter media hollow body having an axially extending hollow interior circumferentially enclosing an outflow passage in an interior of the filter element, the filter media hollow body having:
an inlet flow face arranged on a radially exterior side of the filter media hollow body, the inlet flow face configured to receive air to be filter by the primary filter element;
an outlet flow face arranged in the axially extending hollow interior of the primary filter element;
wherein the fluid to be filtered flows radially through the filter media hollow body from the inlet flow face to the outlet flow face;
a first end disk is secured onto a first axial end of the filter media hollow body,
the first end disk having a central opening extending axially through the first end disk, forming an auxiliary inflow path opening extending from an exterior of the primary filter element into the hollow interior;
wherein the primary filter element is configured such that a primary inflow path enters the primary filter element at the inflow face, is filtered by the primary filter element and reaches the outflow passage within the hollow interior;
an ambient airflow restriction device is arranged at least partially within the hollow interior and sealably closing the central opening;
wherein the ambient airflow restriction device includes filter media and operates as the bypass filter element;
wherein the ambient airflow restriction device includes at least one filter media layer having a significantly higher pressure drop at a given flow rate relative to a pressure drop in the primary filter element from equivalent airflow rate in the primary inflow path, the significantly higher pressure drop operable to limit or prevent airflow through the auxiliary inflow path during normal operation;
wherein, when the primary inflow path is obstructed, the ambient airflow restriction device operates to provide auxiliary airflow into the outflow passage, bypassing the filter media of the filter media hollow body.

12. The primary filter element according to claim 11, wherein
a first one of the at least one filter media layers is a reticulated open cell foam media, the open cell media having a porosity sufficiently restricting airflow through the ambient airflow restriction device to provide the significantly higher pressure drop to limit or prevent airflow through the auxiliary air inflow path;
wherein the open cell foam media is configured to additionally provide filtering of the auxiliary airflow in the auxiliary air inflow path.
wherein a second one of the at least one filter media layers is a cellulose or synthetic filter media arranged on an outflow side of the open cell foam material within the hollow interior of the primary filter element, the second one of the at least one filter media layers providing further filtering of the auxiliary airflow in the auxiliary air inflow path.

13. The primary filter element according to claim 11, wherein
the at least one filter media layer is a cellulose or synthetic filter media sheet.

14. The primary filter element according to claim 11, wherein
the primary filter element together with the ambient airflow restriction device together forms a unitary one-piece component installed and replaced as a single unit.

15. The primary filter element according to claim 11, wherein
the filter element filter media is a pleated filter media.
